(19) United States
(12) Patent Application Publication
(10) Pub. No.: US 2004/0030434 A1
(43) Pub. Date: Feb. 12, 2004

(54) Method for producing an electronic device

(76) Inventors: Joachim Schenk, Meinersen-Ohof (DE); Andreas Geil, Stuttgart (DE); Thomas Spichale, Schoenbrunn (DE); Wolfgang Baierl, Remshalden (DE)

Correspondence Address: KENYON & KENYON, ONE BROADWAY, NEW YORK, NY, 10004, US

(21) Appl. No.: 10/297,875

(22) PCT Filed: May 30, 2001
(86) PCT No.: PCT/DE01/02038

(30) Foreign Application Priority Data
Jun. 10, 2000 (DE) 10028912.6

(51) Int. Cl. G06F 19/00; H02H 3/05

(52) U.S. Cl. 700/110; 714/46

(57) ABSTRACT

A manufacturing method for a device made up of multiple components, including at least one program-controlled component, is described. After the program-controlled component has been installed and before the manufacture of the device is completed, the program-controlled component is caused to execute a test program and the manufacture of the device is only continued if no faults are detected when the test program is run.

### BACKGROUND INFORMATION

The invention relates to a manufacturing method for a device made up of multiple components, at least one of the components being program-controlled.

Such devices are used in many areas of technology and they are becoming more widely disseminated since the progress of microelectronics is constantly simplifying the structure of even highly specialized devices made from modular components and making them more economically attractive.

An economically important example of such a device is, for example, the totality of electronic and electrical control systems of a motor vehicle, described here in short as a control system.

In motor vehicle assembly, it is presently customary to install all the components belonging to the control system in sequence and to perform a function check after completion of assembly at the end of the assembly line. However, such a procedure is unsatisfactory for several reasons. Frequently, it is only possible to correct a fault which is not detected until after assembly has been completed by reversing assembly steps to gain access to such a fault location and repair it. This is not only time-consuming but sometimes it also requires the destruction of parts.

An additional problem results from the increasing complexity of control systems for motor vehicles. Since the individual components of such a control system interact with each other in diverse ways, frequently the occurrence of a fault cannot be unambiguously traced to the defect of a specific component. To be able to localize the cause of a detected fault, it is therefore frequently necessary to induce individual program-controlled components of such a system to execute a test program, which is different from the working program that activates these components in the normal operation of the control system, and is used to verify the proper function of the program-controlled component or of components whose function depends on this last-named component such as sensors or actuators. If the component checked using such a test program proves to be functional, the procedure must be repeated on another one until the defective one is found. Such a procedure is performed using diagnostic testers common to automotive repair shops. Such a procedure is too time-consuming for systematic use in mass production.

### ADVANTAGES OF THE INVENTION

The manufacturing method of the present invention having the characterizing features of the main claim makes it possible to produce complex electrical or electronic devices economically while avoiding time losses resulting from attempts to localize faults and/or avoiding disassembly measures which might otherwise be necessary to gain access to the location of a fault.

It is not necessary to run the test program immediately after the program-controlled component to be tested has been installed; for example, it is conceivable to install multiple such components in sequence and then to test them in a joint operation; however, it is essential for the check to take place at a point in time before assembly is completed when access to the installed components is not made unnecessarily difficult should this be necessary to eliminate a fault.

The test program is preferably stored in a program memory of the program-controlled component before it is installed. This eliminates a time-consuming loading of such a test program before it is executed.

Program parts that are used by the test program and by a working program to be executed by the program-controlled component in normal operation of the device are also advantageously stored in the program memory in advance. This eliminates loading these program parts twice. The “joint use” of program parts by the working program and test program should be understood here in a broad sense; in particular, it also includes such program parts that are only called by the test program with the objective of verifying that the program-controlled component correctly executes these parts.

After the test program is successfully run, it is preferably labeled as executed, erased, or overwritten in the program memory. This step makes it possible to verify at a later time that the test program has been properly executed; in the case of safety-relevant devices in particular, this step makes it possible for an equipment manufacturer to prove that it has satisfied a quality assurance requirement with reference to a specific device even a long time after manufacture.

While the labeling of the test program makes direct proof of its proper execution possible, this is not normally the case with erasing or overwriting. Therefore it is very advantageous if the test program is overwritten with the working program after execution. In such a case, the mere fact that the device in question has functioned correctly once makes it possible to verify that a working program must have been present, and from the presence of the working program, it is possible to infer that the function check of the device must also have been done.

To obtain information concerning possible faults of the program-controlled component, it is advantageous that a diagnostic unit is connected to an interface of the device via which it is possible to receive messages concerning any faults of the program-controlled component detected when the test program is executed.

Since the component is checked while the device is still in an unfinished state at a time when the component may still not have a power supply, it is advantageous that the energy of the program-controlled component required to execute the test program is supplied via the interface.

The same interface may also be used to transfer the working program to the program-controlled component after the test program has been successfully executed.

Objects of the test by the test program expediently include, for example, a check of the connections of the program-controlled component to other parts of the device as well as the proper presence of the program parts used jointly by the working program and the test program. In this case, it is possible to conceive, in particular, of faults of the type that it is neglected during manufacture to load to the program memory a program part which implements a specific performance characteristic of the device to be manufactured or that a program memory is installed which does not contain this program part or that an obsolete version of a program part which no longer satisfies the quality or safety requirements is present in the program memory, or in which, for example, as a consequence of changes to other components of the device, it is not ensured that it will interact smoothly with all other components of the device.

### DRAWING

Exemplary embodiments of the invention are shown in the drawing and are explained in greater detail in the following description.

FIG. 1 shows a schematic view of a diagnostic system to implement the method according to the present invention.

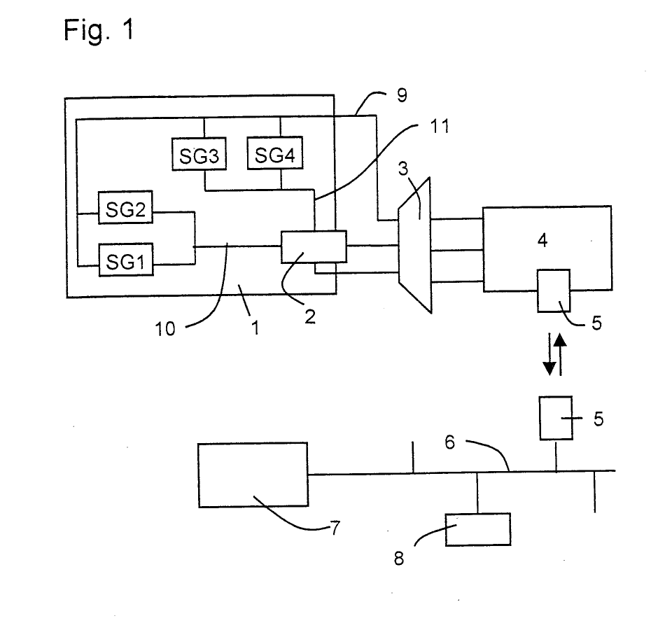

Reference symbol 1 denotes here an electronic or electrical device in the process of being manufactured, such as the entire control system of a motor vehicle which is made up of a large number of components, of which only program-controlled components SG1, SG2, . . . SG4 are shown as an example. These program-controlled components SG1, . . . SG4 may be, for example, a control unit for fuel supply and ignition of the internal combustion engine of the vehicle, an airbag ignition control unit or the like. Each program-controlled component has its own program memory. This memory may be combined with it into one unit and installed together with it in device 1; however, it is also conceivable to install one component and one assigned program memory into device 1 in separate steps.

It is assumed, for example, that SG4 is the most recently installed component. The program memory (not shown) of this component contains a number of program parts which are needed by the working program of component SG4 to be loaded later as well as a test program which when executed makes component SG4 capable of checking which program parts needed by the working program are already contained in the program memory, if the most recent version of these program parts is present and if all contacts of component SG4 are correct for their environment, i.e., if all connectors via which component SG4 exchanges signals with its environment are correctly connected.

In order to check component SG4, a diagnostic tester 4 is connected to device 1 via an interface 3 in the form of a special connector. Diagnostic tester 4 supplies energy to component SG4 and the other components SG1 to SG3 already installed via interface 3 and a supply line 9 so that component SG4 starts to process the test program. Since energy is also supplied to components SG1 to SG3, the test program may address component SG4 via an internal bus system of device 1 such as a CAN-bus 11 and a k-line 10 and check if it is correctly connected to them and receives from them an expected reply to a query. While the test program is being processed, program-controlled component SG4 delivers messages concerning the results of the test to diagnostic tester 4 via CAN-bus 11, a gateway 2, and interface 3. The result messages may be limited to fault messages; however, it is advantageous also to deliver a message concerning the successful conclusion of a test step to diagnostic tester 4.

In the example shown here, diagnostic tester 4 transfers the test results obtained via an interface identified here as infrastructure interface 5 to a test or quality assurance infrastructure of the manufacturer of device 1. The infrastructure interface is preferably a wireless interface; it transfers data, for example in the form of radio or infrared signals. Such a wireless transfer of the test results allows an operator to place diagnostic tester 4 at any location where he/she can easily reach the device to be tested; however, such a wireless connection also makes it possible to leave a diagnostic tester 4 on the device to be tested during its manufacture so that it moves along with the device on a production line in order to address the diagnostic tester via infrastructure interface 5 at individual locations of the production line after a component to be tested has been installed in order to initiate the execution of the test program of that component.

For its part, the testing infrastructure includes an interface 5 complementary and identical in design in particular, to infrastructure interface 5 of diagnostic tester 4, being connected to a bus system 6, to which a computer identified here as DIA server 7 (for diagnosis in assembly) and a display unit 8 are also connected. DIA server 7 may be used to record and archive simply and efficiently all test results obtained in the diagnosis in assembly for a given device 1. In the event the device is involved in an accident or causes a malfunction, this makes it possible for the manufacturer of device 1 to access the test data of the relevant device at any time and thus prove that the device left its premises in a thoroughly tested and proper condition. Furthermore, the collection of test data for a large number of devices in various stages of their manufacture makes it possible to identify production steps that possibly contain a danger to already installed components or may otherwise result in malfunctions.

If the processing of the test program results in the detection of a fault, it may be displayed on display unit 8 in order to prompt an operator to remove device 1 in question so that it may be repaired, if necessary using instructions that are also displayed on display unit 8. The repaired device is again checked for function and only if it passes this check is manufacturing resumed by installation of additional components.

If the aspect of collecting diagnostic data is of secondary importance, the method according to the present invention may also be implemented without elements 5 to 8. In this case (not shown in the figure), diagnostic tester 4 advantageously has a separate display unit 8 in order to display a malfunction of the device being tested as well as instructions to eliminate the malfunction, if necessary.

After the test program has been run successfully, i.e., without detecting faults, it is no longer needed for the manufacture of the device. The program memory in which it is stored may therefore be made available for another use; advantageously, the test program is overwritten with the working program which the component executes during the normal operation for which device 1 is intended.

If device 1 has only one program-controlled component, the working program may be transferred into the working memory immediately after the test program is successfully run. Interface 3 and diagnostic tester 4 may be used to transfer the program data. If device 1 contains multiple program-controlled components, it may be more economical for manufacturing to install and check each of these components in succession and to load the working programs of all program-controlled components of the device after successful completion of all tests.

What is claimed is:

1. A manufacturing method for a device made up of multiple components (SG1, SG2, SG3, SG4), at least one of the components (SG4) being program-controlled in which the program-controlled component (SG4) is caused to execute a test program after the program-controlled component (SG4) has been installed and before the manufacture of the device (1) is completed, and the manufacture of the device (1) is only continued if no faults are detected when the test program is run.

2. The manufacturing method as recited in claim 1,
wherein the test program is stored in a program memory of the program-controlled component (SG4) before the component (SG4) is installed.

3. The manufacturing method as recited in one of the preceding claims,
wherein program parts that are used by the test program and by a working program to be executed by the component (SG4) in normal operation of the device (1) are stored in a program memory of the program-controlled component (SG4) before this component (SG4) is installed.

4. The manufacturing method as recited in claim 2 or 3,
wherein after the test program is run, it is labeled or erased or overwritten in the program memory.

5. The manufacturing method as recited in claim 3,
wherein the test program is overwritten with the working program.

6. The manufacturing method as recited in one of the preceding claims,
wherein a diagnostic unit (4) is connected to an interface (3) of the device (1) in order to receive messages concerning possible faults of the program-controlled component (SG4) detected when the test program is executed.

7. The manufacturing method as recited in claim 6,
wherein the program-controlled component (SG4) is supplied with energy to execute the test program via the interface (3).

8. The manufacturing method as recited in claim 6 or 7 to the extent it refers to claim 5, wherein the working program is transferred to the program-controlled component via the interface (3).

9. The manufacturing method as recited in one of the preceding claims,
wherein if multiple program-controlled components (SG1, SG2, SG3, SG4) of the device (1) are connected, their working programs are transferred in one step after these multiple program-controlled components (SG1, SG2, SG3, SG4) are installed.

10. The manufacturing method as recited in one of the preceding claims,
wherein the running of the test program includes a transfer of the connections of the program-controlled component (SG4) with other parts (SG1, SG2, SG3) of the device (1).

11. The manufacturing method as recited in claim 3,
wherein the running of the test program includes a check of the proper presence of the program parts used jointly by the working program and the test program.
